(19) United States
(12) Patent Application Publication
(10) Pub. No.: US 2003/0056216 A1
(43) Pub. Date: Mar. 20, 2003

(54) SYSTEM FOR MANAGING FAVORITE CHANNELS

(76) Inventors: THEODORE D. WUGOFSKI, FORT WORTH, TX (US); KIM C. SMITH, COLLEYVILLE, TX (US)

Correspondence Address: GATEWAY, INC., 14303 GATEWAY PLACE, ATTENTION: MARK WALKER (MAIL DROP SD-21), POWAY, CA, 92064, US

(21) Appl. No.: 09/002,906

(22) Filed: Jan. 5, 1998

(51) Int. Cl. H04N 7/025; H04N 7/10; G06F 3/00; H04N 5/445; G06F 13/00

(52) U.S. Cl. 725/46; 725/45; 725/34

(57) ABSTRACT

A system for managing favorite channel lists on a television, personal computer or PC/TV convergence environment is disclosed. The favorite channel lists are dynamically created by a computerized system rather than manually created by a user who specifically identifies a set of channels to be included in the favorite channel list. In one embodiment of the invention, the computerized system generates a list of favorite channels based on a theme selected by the user. In another embodiment of the invention, the computerized system generates a list of favorite channels based on the channels most frequently viewed by the user.

### RELATED APPLICATIONS

This application is related to the co-assigned and co-filed applications, “Method for managing multiple channel maps from multiple input devices in a multimedia system,” “Previous, favorite, and frequent channel management system,” “System for time-shifting events in a multi-channel convergence system,” “System, apparatus, and method for tuning a television to a selected channel,” and “A system for resolving channel selection in a multi-channel convergence system,” all of which are hereby incorporated by reference.

1. Field of the Invention

The present invention relates generally to a computerized system for managing favorite channels and more specifically to dynamically managing favorite channel lists based on a user-specified theme or actual usage by the user.

2. Background of the Invention

Favorite channel lists are becoming a common feature on television (TV) systems and Internet computing systems. For example, present digital satellite system (DSS) set-top boxes provide favorite TV channel lists that support a user specifically selecting a set of favorite channels. Likewise, Internet web browsers such as Netscape Navigator, available from Netscape Communications Corp., of Mountain View, Calif., and Microsoft Internet Explorer, available from Microsoft Corporation, of Redmond, Wash., allow the user to specifically select a set of favorite channels. Such user selected sets of favorite Internet channels are referred to as “Bookmarks” by Netscape Navigator and “Favorites” by Internet Explorer.

The presently available favorite channel lists (“favorites lists”) are created by the user specifically selecting which channels are to be in the favorites list. For example, most DSS set-top boxes will display user interfaces for specifying a channel and adding it to the favorites list. However, creating the favorites list initially takes time for the user. Additionally, to maintain an up-to-date list, the user must continually add channels to the list or remove channels from the list.

One disadvantage of present systems for managing favorite channels is that performing the functions to add favorite channels to lists or remove favorite channels from lists requires the user's time. Accordingly, there is a need for favorite channel lists that are dynamically created and updated by a TV, a computer or an integrated personal computer and television system.

Another disadvantage of present systems is that the favorites lists can only be created by the user specifically identifying which channels are to be in the favorites list. Present systems do not offer favorite channel lists dynamically organized by theme for example. Thus, the present favorites lists are only as organized as the user who created them. This presents an inconvenience to users of such systems.

### SUMMARY OF THE INVENTION

The above-identified shortcomings as well as other shortcomings are addressed by the present invention, which will be understood by reading and studying the following specification.

The invention describes a computerized system in which favorite channel lists are automatically and dynamically managed. In accordance with one aspect of the invention, the contents of favorite channel lists are based on a user specified theme. The computerized system automatically identifies channels showing events relating to the user specified theme and includes the events in the favorites list. In order to identify channels showing events related to the user specified theme, the user specified theme corresponds to the contents of an EPG (electronic program guide) content database which stores events available on the channels for a period of time.

In accordance with another aspect of the invention, the contents of a favorites list are based on the user's actual usage of the computerized system. The computerized system monitors the users actual usage of the channels. The most frequently used channels are stored in a favorite channel list for the particular user.

Therefore, the user does not have to create and update the favorites lists manually because the lists are created and updated automatically by the computerized system. In addition, the user can have favorites lists organized by theme or by the user's actual usage of the computerized system.

In different embodiments of the invention, computers and computerized systems of varying scope are described. Still other and further embodiments, aspects and advantages of the invention will become apparent by reference to the drawings and by reading the following detailed description.

### BRIEF DESCRIPTION OF THE DRAWINGS

FIG. 1 is a diagram of a typical convergence system in conjunction with which embodiments of the invention may be implemented.

FIG. 2 is a diagram of the computerized system for managing collections of favorite channels in the convergence system of FIG. 1 according to one embodiment of the invention;

FIG. 3 is an illustration of a channel map database of the system of FIG. 2;

FIG. 4 is an illustration of an EPG content database of the system of FIG. 2;

FIG. 5 is an illustration of a favorites database of the system of FIG. 2;

FIGS. 6A, 6B and 6C together are a table identifying themes and sub-themes specified in the Direct Broadcast Satellite (DBS) content descriptors.

### DESCRIPTION OF THE EMBODIMENTS

In the following detailed description of the embodiments, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following detailed description is, therefore, not to be taken in a limiting sense, and the scope of the present invention is defined only by the appended claims.

The embodiments described in the present application can be implemented on a computerized system architecture for an integrated personal computer and television system such as provided by the co-filed, co-pending and co-assigned U.S. patent application entitled “Architecture for Convergence Systems,” which is hereby incorporated by reference. Integrated personal computer and television systems are known in the art as a “convergence environment” in which a personal computer (PC) is integrated with other capability, such as and usually including at least television (TV) capability. Such hardware components are known and available within the art. For example, the Gateway Destination PC/TV system, available from Gateway 2000, Inc., provides a convergence environment across two primary modes of operation: TV viewing, and PC operation (i.e., such that the system provides TV and PC capability).

### Typical Convergence Environment

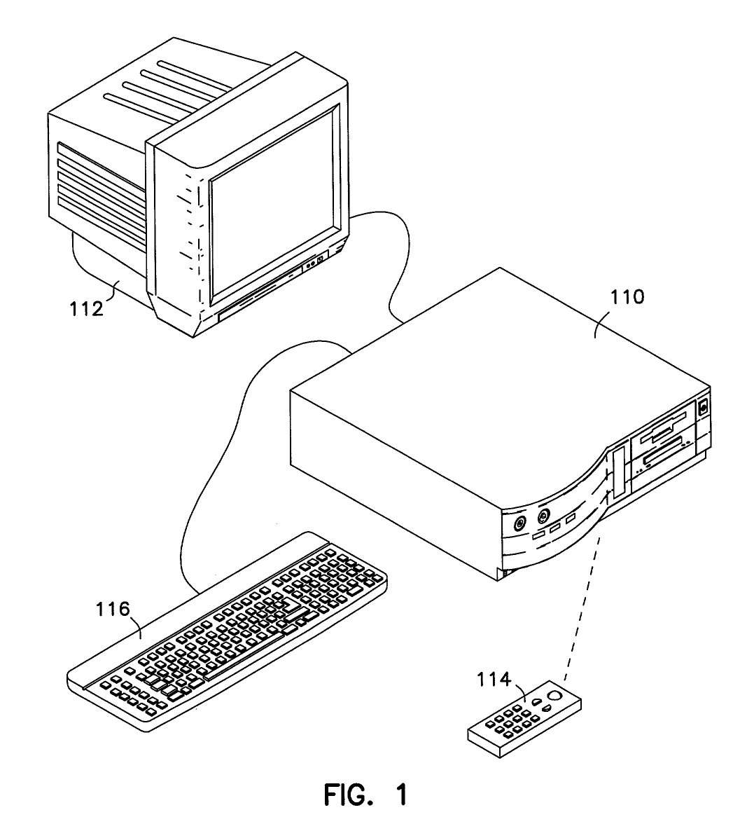

FIG. 1 is a diagram of a typical computer in conjunction with which embodiments of the invention may be implemented. Computer 110 is operatively coupled to monitor 112, pointing device 114, and keyboard 116. The computerized system provides the hardware component and the software architecture as has been described herein. Computer 110 includes a processor (preferably, an Intel Pentium processor), random-access memory (RAM) (preferably, at least thirty-two megabytes), read-only memory (ROM), and one or more storage devices, such as a hard disk drive, a floppy disk drive (into which a floppy disk can be inserted), an optical disk drive, and a tape cartridge drive. The memory, hard drives, floppy disks, etc., are types of computer-readable media. The invention is not particularly limited to any type of computer 110. Computer 110 preferably is a PC-compatible computer running a version of the Microsoft Windows operating system. The construction and operation of such computers are well known within the art.

Computer 110 includes integrated therein or coupled thereto hardware to provide for what is known in the art as a “convergence environment” such that computer 110 provides capability beyond ordinary PC operation. Such capability preferably including TV capability. For example, the Gateway Destination PC/TV system, available from Gateway 2000, Inc., provides a convergence environment across two primary modes of operation: TV viewing, and PC operation. Computer 110 desirably provides for integration with or includes audio/video (i.e., multimedia) devices including but not limited to: a sound card, a digital video disc (DVD) player, a direct broadcast satellite (DBS) receiver, a TV tuner (for broadcast and/or cable TV), audio/video inputs for external or auxiliary devices, a CD-ROM player, an audio/video tuner having at least radio tuning capability, a cable decoder, a video cassette recorder, a laser disc player, a compact disc player, a DBS integrated receiver-decoder (IRD), and a video camera.

Computer 110 may also be communicatively connected to the Internet in any particular manner, by which the invention is not limited to and which is not shown in FIG. 1. Internet connectivity is well known within the art. In one embodiment, the computer includes a modem and corresponding communication drivers to connect to the Internet via what is known in the art as a “dial-up connection.” In another embodiment, the computer includes an Ethernet or similar hardware card to connect to a local-area network (LAN) that itself is connected to the Internet via what is know in the art as a “direct connection” (e.g., T1 line, etc.). In further embodiments, the computer may be connected to the Internet using a cable modem or satellite Internet connectivity.

Monitor 112 permits the display of information, including computer, video and other information, for viewing by a user of the computer. The invention is not limited to any particular monitor 112. Such monitors include cathode ray tube (CRT) displays, as well as flat panel displays such as liquid crystal displays (LCD's). The monitor is, however, desirably a 31″ VGA monitor. Pointing device 114 permits the control of the screen pointer provided by the graphical user interface of operating systems such as versions of Microsoft Windows. The invention is not limited to any particular pointing device 114. Such pointing devices include mouses, touch pads, trackballs, remote controls and point sticks. Finally, keyboard 116 permits entry of textual information into computer 110, as known within the art, and the invention is not limited to any particular type of keyboard. Desirably, keyboard 116 is a wireless keyboard.

In a convergence environment, a channel refers to a communications path between devices. For example, TV channels refer to particular frequencies at which radio waves are transmitted. In a convergence environment, an event refers to a specific happening or occurrence on a particular channel. For example, an event on a TV channel may be a specific TV program. An event on an Internet channel may be a scheduled Internet chat session. However, the invention is not so limited to such channels or events.

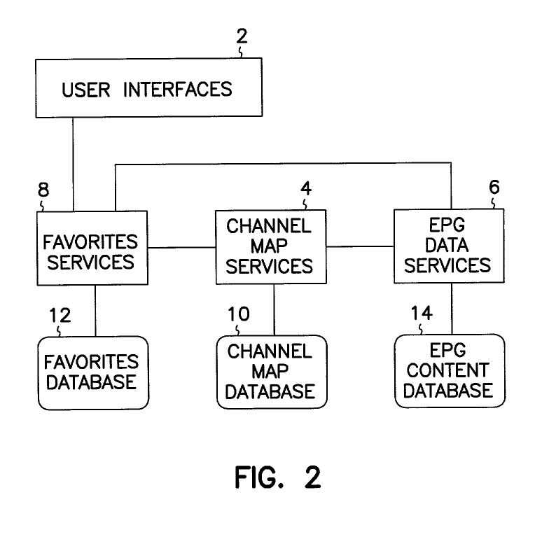

FIG. 2 is a diagram of the computerized system for managing collections of favorite channels in a television or a convergence environment. As illustrated in FIG. 2, the system consists of: application user interfaces 2, channel map services 4, electronic program guide (EPG) data services 6 and favorites services 8. The system also includes a channel map database 10, an EPG content database 14 and a favorites database 12.

The application user interfaces 2 provide a means for the user to access the system.

### Channel Map Services

The channel map services 4 manages the channel map database 10 that describes the channels available to the system. Channel map services 4 provides functions for creating a logical tuning space that maps logical channel numbers to physical tuning devices and the specific channel, sub-channel, etc., on the device. For example, a given hardware component in conjunction with which the software architecture operates may have access to a number of channel sources, such as cable TV, broadcast TV, and one or more satellite TV sources. Each of these sources may also have a similar channel mapping, such that cable TV has channels 2-50, broadcast TV has channels 2-13, and satellite TV has channels 2-194.

Thus, specifying a particular channel—for example “channel 2”—does not uniquely identify a given channel, since there may be three channel 2's. Therefore, channel map services 4 alleviates this problem by mapping logical channel numbers to actual channel numbers accessible on the number of channel sources. For example, channel map services 4 may map cable TV channels 2-50 as logical channels 1-49, broadcast TV channels 2-13 as logical channels 50-61, and satellite TV channels 2-194 as logical channels 62-254. Therefore, specifying a particular logical channel always uniquely identifies a given channel. Channel map services 4 is thus called to determine the corresponding physical channel number and the corresponding physical device for a given logical channel number, and vice-versa.

### Favorites Services

The favorites services 8 manages the favorites database 12 that describes the collection of favorite channel lists and the channels that compose these lists. Favorites services 8 provides favorites list management functions, and also a set of common user interfaces for selecting a favorite item from a list, adding an item to a favorite list, and removing an item from a favorite list. Thus, an application calls favorites services 8 when it wishes to add or delete an item such as a channel from a given favorites list. The favorites services 8 provides both the functionality to maintain the favorites list, as well as the user interface to allow a user to add or delete an item from the list, name lists, rename lists, add lists and remove lists. Thus, regardless of which application calls favorites services, the interface presented to the user remains consistent.

### EPG Data Services

The EPG data services 6 function manages the EPG content database 14 that describes the events available on the channels for a period of time. EPG data services 6 provides functions for loading electronic program guide-type data from data services. Such data services may be communicated with through a modem, over the Internet, over a satellite, through the vertical blanking interval (VBI) of a TV program, etc.; the invention is not so particularly limited. EPG data services 6 also provides a database API (Application Program Interface) for accessing the data and common user interfaces for configuring the loading functions. Thus, an application may use EPG data services 6 to determine what is programmed to be televised on a given logical channel at a given time; the EPG data services 6 may then call channel map services 4 to determine the corresponding physical channel and physical device, and then load the relevant EPG if necessary before returning the requested information to the application.

The architecture of the EPG data services 6 is based on a modular approach, such that EPG providers may be added to the EPG database. EPG data services 6 thus provides an abstraction layer between the providers of the EPG data and the applications that use the data. If the provider of a given set of EPG data changes, for example, only the relevant EPG data services 6 need to be modified; the applications that utilize these data services do not. The modular nature of the EPG data services 6 also permits the integration of EPG data from multiple sources. For example, EPG data relating to satellite TV may originate from one particular provider, whereas EPG data relating to broadcast TV may originate from another particular provider.

### Channel Map Database

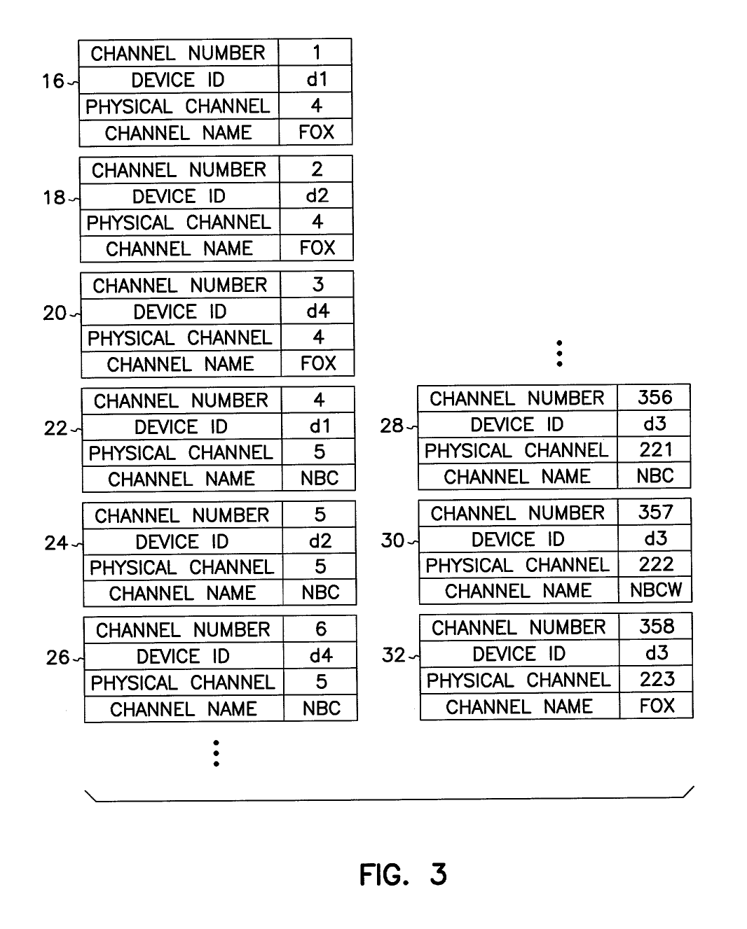

FIG. 3 is an illustration of how the channels available on each device in the system are stored in a database of channel and device associations referred to herein as the channel map database 10. Since some devices may provide the same channel, duplicates may appear in the channel map database 10. The channels are identified in linear tuning space and numbered using logical channel numbers. In FIG. 3, the first channel 16 is logical channel 1 while the last channel 32 is logical channel 358. Logical channel 1 16 is identified as being available on physical channel 4 on device d1; logical channel 1's call letters are “FOX.” In real world terms, this means that the FOX channel is available on the internal TV tuner when it is tuned to channel 4. Logical channel 2 18 is identified as being available on physical channel 4 on device d2; its call letters are also “FOX.” In real world terms, this means that the FOX channel is also available through the first VCR when the first VCR is tuned to channel 4. The FOX channel is also found at logical channel 3 20 and logical channel 358 32. The NBC channel can be found on logical channel 4 22, logical channel 5 24, logical channel 6 26, and logical channel 356 28. The west coast version of NBC (NBCW) can be found on logical channel 357 30.

### EPG Database

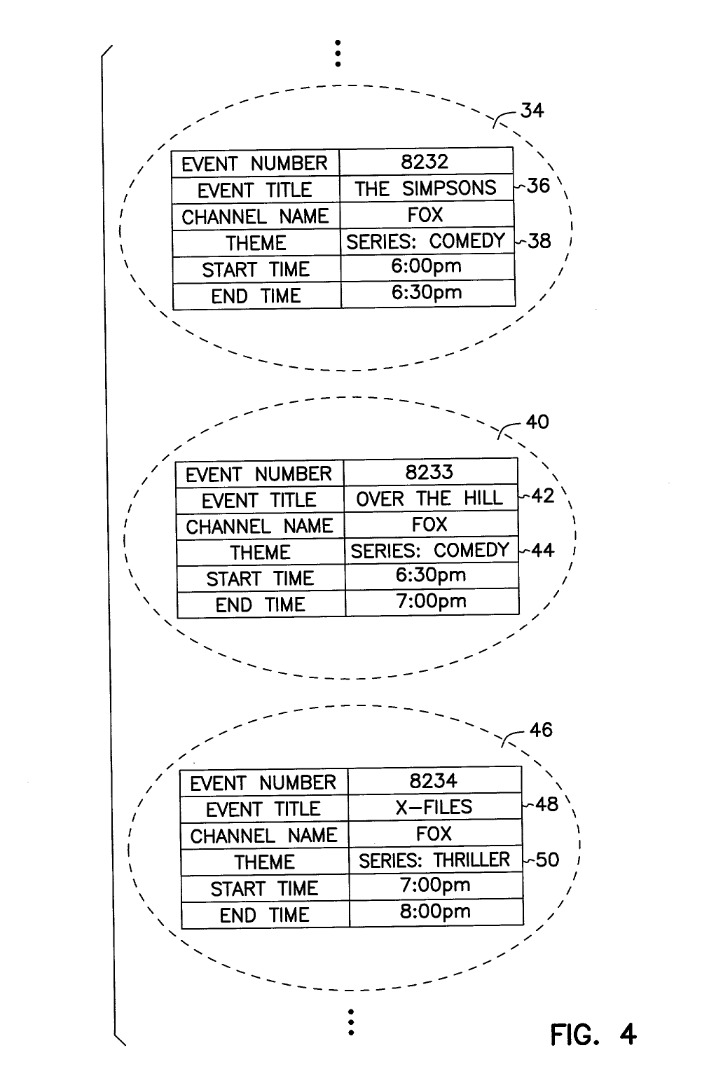

FIG. 4 is an illustration of how the events available on the different channels may be stored in a database referred to herein as the EPG content database 14. In FIG. 4, three events are shown in the database. The first event 34 has the title 36 of “The Simpsons,” and the theme 38 is “comedy series.” The second event 40 has the title 42 “Over the Hill,” and the theme 44 is also “comedy series.” The third event 46 has the title 48 “X-Files,” and its theme 50 is “thriller series.”

### Favorites Database

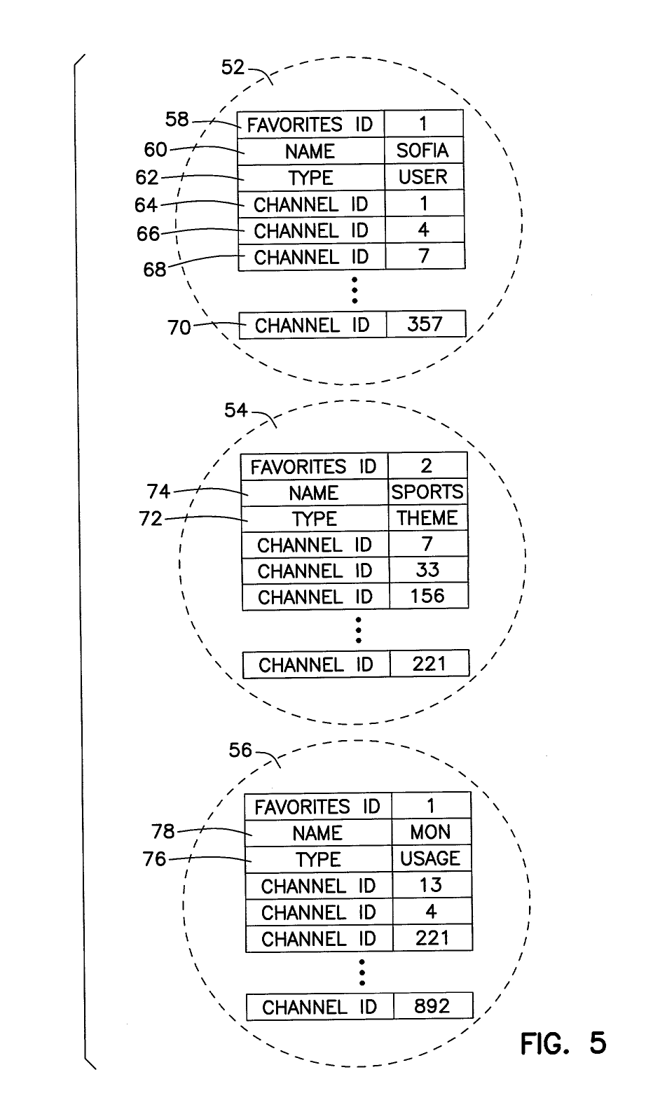

FIG. 5 is an illustration of how channels might be stored in a database of favorite channels referred to herein as the favorites database 12. In FIG. 5, the favorites database 12 contains a collection of favorite lists. The first favorite list 52, the second favorite list 54 and the last favorite list 56 are shown.

In the first favorite list 52, the favorite list identifier 58 is a unique identifier for the record. The name 60 corresponds to the person who created the list. The type 62 indicates the type of favorites list; in this case, it is a “user-specified” list of favorite channels. The channel identifiers 64, 66, 68, 70 indicate the first few and last channels in the favorite list. The first channel in the favorite list 64 is channel “1” and the last channel 70 is channel “357”. In a user-specified favorite list, the user has specifically identified which channels are in the favorite list.

### Theme-Based Favorites List

In the second favorite list 54, the type 72 of favorite list is a “theme-based” favorites list and the name 74 of the favorites list is “Sports.” In a theme-based favorites list, the user specifies the type of events that the user wishes to include in the list, and the system dynamically, and automatically, determines what channels are showing an event of that type; these channels are then included in the favorites list.

The theme-based favorites list requires that the favorites list correspond to the current contents of the EPG content guide. There are several primary parameters that affect what channels are in the favorites list, including: the selected theme, selected sub-theme, matching of generic sub-themes, number of time slots to consider for inclusion and update frequency.

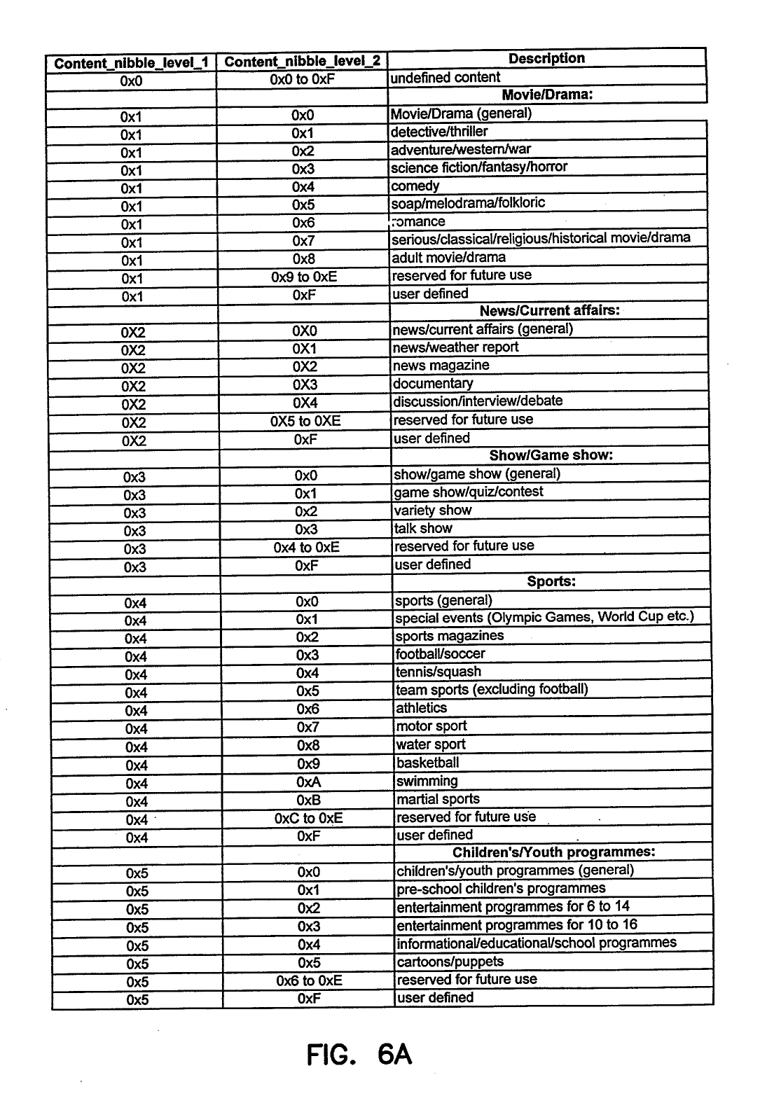

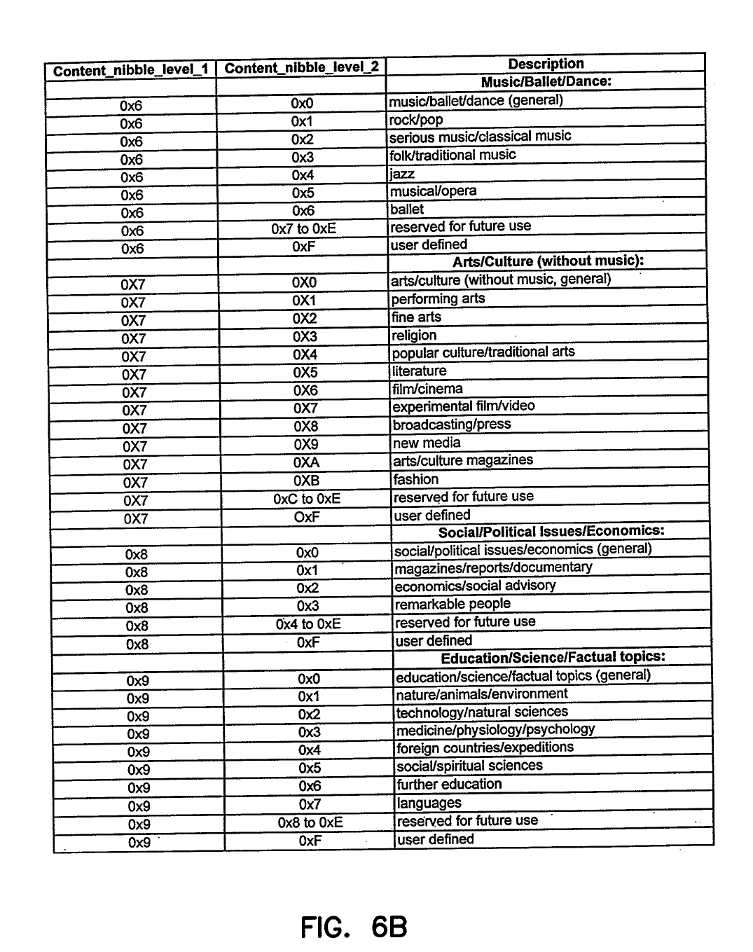

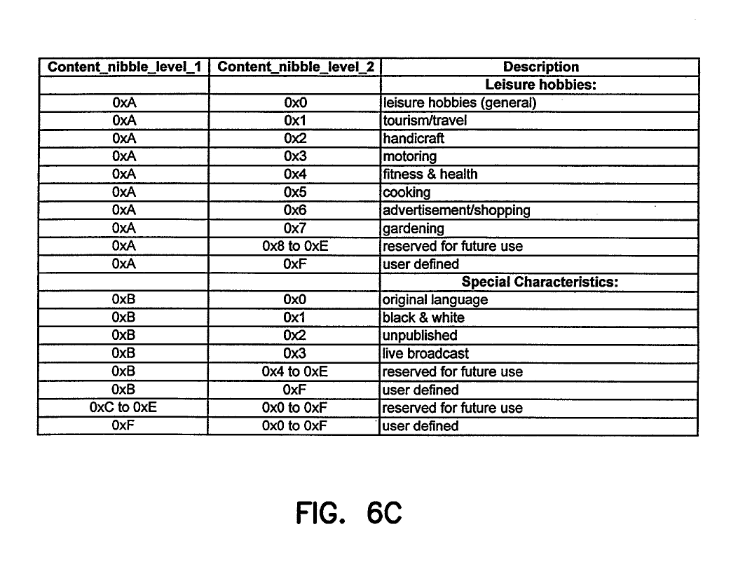

The selected theme and selected sub-theme may be from a set of predefined keywords (as is the case with DSS, DBS, and Advanced Television Systems Committee (ATSC) standards) that may or may not include sub-themes. FIGS. 6A, 6B and 6C are a table of direct broadcast satellite (DBS) content descriptors. FIGS. 6A, 6B and 6C identify the themes and sub-themes specified in the DBS standard. The film “12 Monkeys” might be classified with a “movie” theme and a “science fiction/fantasy/horror” sub-theme. Some events may be classified with a theme but not with a sub-theme (or classified with the generic sub-theme). In this case, the film “Brazil” might be classified with a “movie” theme and a “movie/drama (general)” sub-theme. If generic sub-themes are considered to match, if a search is made for “science fiction movies,” the generically classified “Brazil” will match.

The number of time slots to consider constrains how far ahead in time to consider in identifying matching channels. If the EPG content database 14 contains programming for the next two weeks, the system may constrain the search to include only channels that are showing the themed event within the next several hours.

The update frequency indicates how often and when to search and recompute the theme-based favorite list. In general, this parameter is coupled with the granularity of the time slots. If the time slots are in 30 minute increments, the system will likely want to update no less than every 30 minutes in order to maintain a consistent duration of events. The system may update more frequently if the EPG content delivery system updates events in the database more frequently than the time slot granularity.

The system for determining favorite lists based on theme could also be extended to build dynamic favorite lists based on searching the event description. For example, a favorite channel list could be created to show all channels showing movies with “John Wayne” in the description.

### Usage-Based Favorites List

In the third favorite list 56, the type 76 of favorite list is a “usage-based” favorite list, and the name 78 is “Monday.” In a usage-based favorites list, the user specifies a day or set of time slots and the system monitors actual usage of the system during that day or time slot, generating a list of the channels most watched on that day or time slots. Sets of time slots may include “prime time,” “morning,” and “late night.” Further, a description of a system for identifying frequently used channels is described in the co-pending, co-filed and co-assigned application entitled “Previous, Favorite, and Frequent Channel Management System,” which is hereby incorporated by reference.

The previously described embodiments of the present invention have many advantages, including creating and updating favorite channel lists automatically rather than requiring a user to have to create and update the favorite channel lists manually. In addition, the user can have favorites lists organized by theme or by the user's actual usage of the computerized system.

The embodiments of the invention described in the present application can be implemented in a television user interface (either digital or analog), a web TV set-top box, a PC/TV convergence platform, a computer or information handling system. However, the present invention is not limited to such implementations and alternate implementations are contemplated and are within the scope of this invention.

Other mechanisms for managing favorite channel lists will be apparent to those skilled in the art. It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A computerized system for managing favorite channels based on a user specified theme, the computerized system comprising:
one or more favorite channel lists, the favorite channel lists comprising one or more logical channels relating to the user specified theme, wherein the computerized system identifies the logical channels showing an event of the user specified theme and includes each of the logical channels in the favorite channel list; and
a favorites database for storing one or more favorite channel lists.

2. The computerized system of claim 1, further comprising an EPG content database storing a plurality of events available on one or more channels for a period of time.

3. The computerized system claim 2, wherein the user specified theme corresponds to a theme field of the events in an EPG content database.

4. The computerized system of claim 3, further comprising an EPG data service for managing the EPG content database, the EPG data service providing functions for loading electronic program guide-type data from one or more data services.

5. The computerized system of claim 1, further comprising a favorites service providing one or more user interfaces and a plurality of management functions for each one of the favorite channel lists.

6. The computerized system of claim 5, wherein the management functions include at least one function selected from the group of functions consisting of: adding a favorite event to one of the favorite channel lists, removing a favorite event from one of the favorite channel lists, and selecting a favorite event from one of the favorite channel lists.

7. The computerized system of claim 1, further comprising a channel map service for determining a physical channel number and a corresponding physical device for each one of the logical channels.

8. A computerized system for managing favorite channels comprising:
one or more favorite channel lists, the favorite channel lists comprising one or more logical channels relating to a user specified theme, wherein the computerized system identifies the logical channels showing an event of the user specified theme and includes such logical channels in the favorite channel list;
application user interfaces for allowing a user to access the computerized system;
channel map services for mapping a logical channel number in the favorite channel list to a physical channel number on a physical device available to the computerized system;
favorites services providing user interfaces and management functions for each one of the favorite channel lists; and
electronic program guide content services for determining what is programmed on the logical channel and for calling channel map services to determine the corresponding physical channel and physical device.

9. The computerized system of claim 8, further comprising a channel map database for storing an association between each one of the logical channels and a physical channel and a corresponding physical device.

10. The computerized system of claim 8, wherein the management functions of the favorites service include at least one function selected from the group of functions consisting of: adding one of the logical channels to one of the favorite channel lists, removing one of the logical channels from one of the favorite channel lists, and selecting one of the logical channels from one of the favorite channel lists.

11. The computerized system of claim 8, further comprising a favorites database for storing one or more favorite channel lists.

12. The computerized system of claim 8, further comprising an electronic program guide content database for storing events available on the one or more channels for a period of time.

13. A computerized system for managing channels, comprising:
one or more channels;
a means for storing one or more events occurring on each one of the channels, each one of the events having a means for identifying a theme; and
one or more means for maintaining a set of channels, each means for maintaining the set of channels comprising the channels having the events relating to a user-specified theme, wherein the computerized system identifies the set of channels by matching the user specified theme to the means for identifying the theme of the event.

14. The computerized system as claimed in claim 13, further comprising a means for maintaining a database, the database consisting of each one of the means for maintaining the set of channels.

15. The computerized system as claimed in claim 14, further comprising a means for loading data about the events from one or more data services.

16. The computerized system as claimed in claim 15, further comprising a means for providing one or more user interfaces and a plurality of management functions for each one of the means for maintaining one or more sets of channels.

17. The computerized system of claim 16, wherein the channel is a logical channel.

18. The computerized system of claim 17, further comprising a means for determining a physical number and a corresponding physical device for each one of the logical channels.

19. A method of using a computerized system to dynamically managing favorite channel lists relating to a user specified theme, the method comprising the steps of:
identifying one or more channels showing an event of a user specified theme, wherein the step of identifying is achieved by matching one or more event themes from an EPG content database to the user-specified theme, and
including each one of the channels in a favorite channel list.

20. The method of claim 19, wherein the step of identifying is achieved by matching one or more event sub-themes from an EPG content database to the user-specified theme.

21. The method of claim 19, wherein the step of identifying is achieved by matching one or more generic event sub-themes from an EPG content database to the user-specified theme.

22. The method of claim 19, wherein the logical channels identified during the step of identifying depend on an update frequency of the EPG content database and a number of time slots included in the favorite channels list.

23. The method of claim 19, wherein the step of identifying is achieved by matching one or more words in a event description from the EPG content database to the user-specified theme.

24. A computer comprising:
a processor;
a computer-readable medium; and
a plurality of computer instructions executed from the computer readable medium by the processor for performing the steps of identifying one or more channels showing an event of a user specified theme and including each one of the channels in a favorite channel list.

25. A computer readable medium having computer executable instructions stored thereon for execution on a computer, the computer executable instructions comprising the steps of:
identifying one or more channels showing an event of a user specified theme, wherein the step of identifying is achieved by matching one or more event themes from an EPG content database to the user-specified theme, and
including each one of the channels in a favorite channel list.

26. The computer readable medium of claim 25, wherein the step of identifying is achieved by matching one or more event sub-themes from an EPG content database to the user-specified theme.

27. The computer readable medium of claim 25, wherein the step of identifying is achieved by matching one or more generic event sub-themes from an EPG content database to the user-specified theme.

28. The computer readable medium of claim 25, wherein the channels identified during the step of identifying depend on an update frequency of the EPG content database and a number of time slots included in the favorite channels list.

29. The computer readable medium of claim 25, wherein the step of identifying is achieved by matching one or more words in a event description from the EPG content database to the user-specified theme.

30. A computerized system for managing favorite channels based on actual usage comprising:
one or more favorite channel lists, the favorite channel lists comprising one or more logical channels relating to a users actual usage, wherein the computerized system monitors usage of a plurality of physical channels for a predetermined time and includes the logical channel identifier for the physical channels used most frequently in the favorite channel list; and
a favorites database for storing one or more favorite channel lists.

31. The computerized system of claim 24, wherein the predetermined time is a twenty-four period.

32. The computerized system of claim 24, wherein the predetermined time is a time slot.

33. A computerized system for dynamically managing favorite channels based on actual usage by a user, the computerized system comprising:
one or more favorite channel lists, the favorite channel lists comprising one or more logical channels, wherein the computerized system identifies the logical channels that have been viewed most often by the user; and
a favorites database for storing one or more favorite channel lists.
